(19) United States
(12) Patent Application Publication
(10) Pub. No.: US 2026/0194142 A1
(43) Pub. Date: Jul. 9, 2026

(54) UTILITY POLE HOLE PLUG

(71) Applicant: Western Utility Solutions, Inc., Aliso Viejo, CA (US)

(72) Inventor: Gregory Ian Albertyn, San Juan Capistrano, CA (US)

(21) Appl. No.: 19/445,193

(22) Filed: Jan. 9, 2026

Related U.S. Application Data
(60) Provisional application No. 63/743,587, filed on Jan. 9, 2025.

(51) Int. Cl. F16J 15/06

(52) U.S. Cl. CPC F16J 15/06

(57) ABSTRACT

A hole plug assembly for plugging a hole of a utility pole includes a bolt, a toggle assembly engaged with the bolt, a retainer supported by the bolt, and a seal supported by the bolt and located between the retainer and the toggle assembly. A position of the retainer along an axis of the bolt can be adjusted and thereafter the retainer resists movement along the axis in response to a force below a threshold. In some configurations, the retainer is a flat washer that includes a main body portion surrounding an opening and at least one tab extending from the main body portion towards the opening. In some configurations, the seal is a curved seal washer.

### INCORPORATION BY REFERENCE TO ANY PRIORITY APPLICATIONS

This application claims benefit of U.S. Provisional Patent Application No. 63/743,587 filed Jan. 9, 2025, pending, the entirety of which is hereby incorporated by reference herein and made a part of the present disclosure. Any and all applications for which a foreign or domestic priority claim is identified in connection with the present application are hereby incorporated by reference herein and made a part of the present disclosure.

### BACKGROUND

### Field

The present disclosure generally relates to a system to plug a hole. In particular, the present disclosure relates to a system to plug a hole in a hollow utility pole, which may be a non-wood material (e.g., metal or composite) utility pole.

### Description of Related Art

Systems or components to plug holes, such as those in hollow utility poles, exist. However, such systems and components have disadvantages or limitations. For example, simple plugs can be used and are convenient to install but may not be secure over time and need to be provided in multiple sizes to address the different hole sizes commonly used in utility poles. Other systems that can accommodate various hole sizes can be expensive and/or difficult to install.

### SUMMARY

There exists a need for simple, reliable, and adaptable hole plug assembly that is easy to use and complies with the various sized holes commonly provided in hollow utility poles, which this system addresses and/or provides public with a unique and convenient solution.

The systems, methods, and devices described herein have innovative aspects, no single one of which is indispensable or solely responsible for their desirable attributes. Without limiting the scope of the claims, some of the advantageous features will now be summarized.

In some aspects, a hole plug assembly for plugging a hole of a utility pole includes a bolt, a toggle assembly engaged with the bolt, a retainer supported by the bolt, and a seal supported by the bolt and located between the retainer and the toggle assembly. The seal is curved in a direction perpendicular to an axis of the bolt.

In some aspects, the seal is a seal washer.

In some aspects, the seal washer is flexible to allow the seal washer to conform to a shape of a portion of an outer surface of the utility pole surrounding the hole plugged by the hole plug assembly.

In some aspects, a diameter of the retainer is between about 60-100%, between about 75-100%, or between about 85-100% of the diameter of the seal.

In some aspects, the retainer is a flat washer.

In some aspects, a hole plug assembly for plugging a hole of a utility pole includes a bolt, a toggle assembly engaged with the bolt, a retainer supported by the bolt, and a seal supported by the bolt and located between the retainer and the toggle assembly. A position of the retainer along an axis of the bolt can be adjusted and thereafter the retainer resists movement along the axis in response to a force below a threshold.

In some aspects, the retainer is a flat washer.

In some aspects, the flat washer comprises a main body portion surrounding an opening and at least one tab extending from the main body portion towards the opening.

In some aspects, the at least one tab has a smaller thickness than a thickness of the main body portion.

In some aspects, the at least one tab comprises a plurality of tabs.

In some aspects, the retainer is slidable along the axis of the bolt.

In some aspects, the seal is a seal washer.

In some aspects, the seal washer is curved.

In some aspects, the seal washer is flexible to allow the seal washer to conform to a shape of a portion of an outer surface of the utility pole surrounding the hole plugged by the hole plug assembly.

In some aspects, a diameter of the retainer is between about 60-100%, between about 75-100%, or between about 85-100% of the diameter of the seal.

In some aspects, the diameter of the retainer is at least about 60%, at least about 75%, or at least about 85% of the diameter of the seal.

In some aspects, the diameter of the seal is at least about 1 inch, at least about 2 inches, or at least about 3 inches.

In some aspects, the diameter of the seal is between about 1 inch and about 4 inches, between about 1 inch and about 3 inches, or between about 1 inch and about 2 inches.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a perspective view of a hole plug assembly having certain features, aspects, and advantages of the present disclosure prior to insertion of the hole plug into the utility pole.

FIG. 2 is a perspective view of a retainer of the hole plug assembly of FIG. 1.

FIG. 3 is a side view of a seal of the hold plug assembly of FIG. 1.

FIG. 4 is a perspective view of the hole plug assembly of FIG. 1 prior to insertion in a hole of a hollow utility pole.

FIG. 5 is a perspective view of the hole plug assembly of FIG. 1 in a partially installed state in the hole of the hollow utility pole of FIG. 4.

FIG. 6 is a side view of the hole plug assembly of FIG. 1 in a fully assembled state in the hole of the hollow utility pole of FIG. 4.

FIG. 7 is a perspective view of the hole plug assembly of FIG. 1 in the fully assembled state as shown in FIG. 6.

### DETAILED DESCRIPTION

Hollow electrical or utility poles are usually constructed of a non-wood material, such as a metal or a composite material. Hollow utility poles are provided with a plurality of permanent openings or holes spaced along a height of the pole and that pass through the wall thickness of the pole. The holes are configured to accept a hardware attachment. The hardware attachment can be a step, a plurality of which are assembled to the pole to allow a utility worker or lineman (“technician”) to climb the pole. However, other attachments could also be connected to the pole using the holes. Typically, only a portion of the holes will be used. It is desirable to plug the unused holes to eliminate the ingress of moisture, debris, or pests. For example, plugs can be desirable to inhibit or prevent bees and wasps from creating nests in the pole or to keep unwanted insects or other animals from entering the interior space of the hollow pole. Furthermore, the plugs can be desirable to reduce or eliminate the potential for unwanted sound caused by wind passing along or through the holes. Ease of use is desirable in the hole plugs assemblies (or, simply, “hole plugs”) because the technicians cannot access the interior of the poles. It is also desirable that the hole plugs be robust and that a single hole plug is capable of use with multiple hole sizes.

Embodiments of the hole plug will now be described with reference to the accompanying figures, wherein like numerals refer to like or similar elements throughout. Although several embodiments, examples, and illustrations are disclosed below, it will be understood by those of ordinary skill in the art that the inventions described herein extend beyond the specifically disclosed embodiments, examples, and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

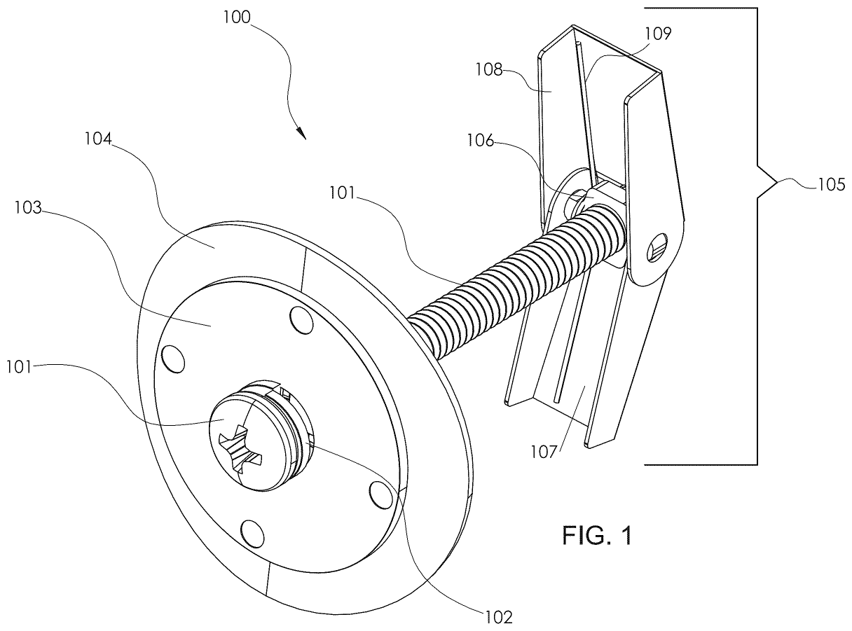

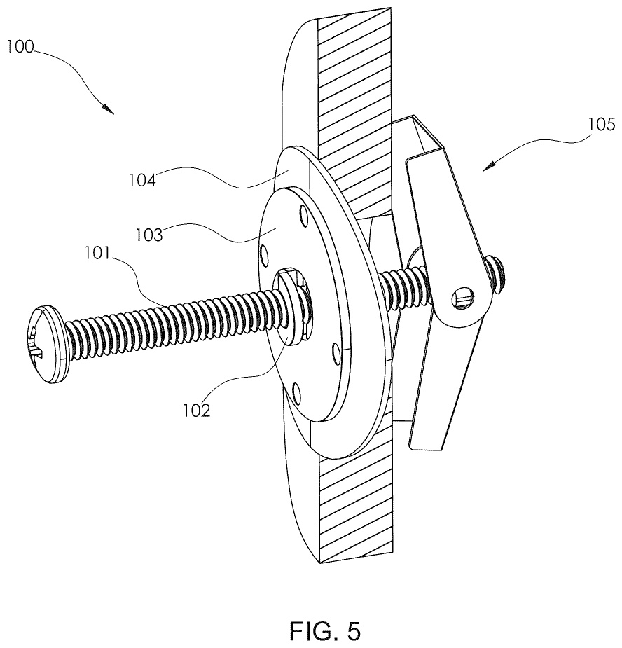

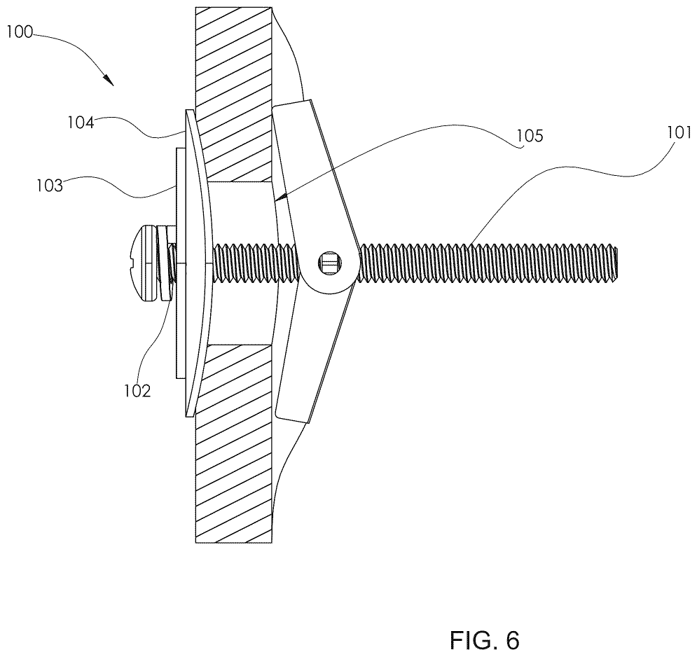

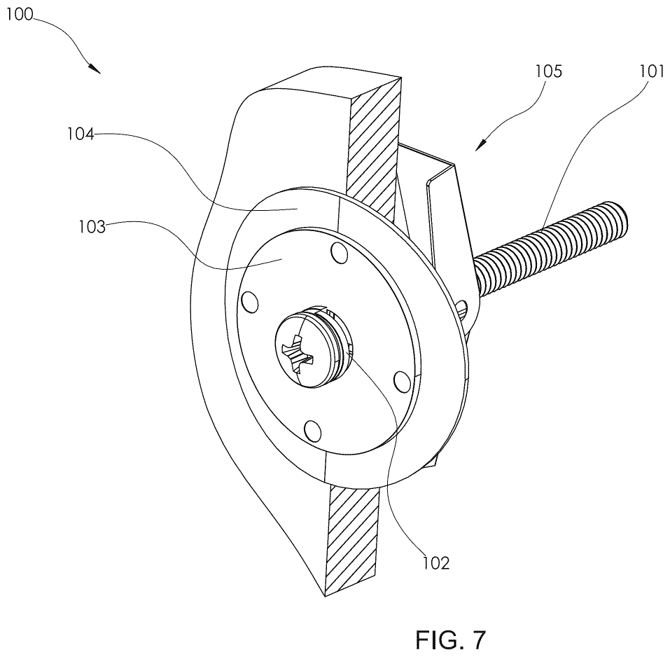

FIGS. 1-7 illustrate an embodiment of a hole plug assembly 100 (also referred to herein as “a hole plug”) having certain features, aspects, and advantages of the present disclosure. The illustrated hole plug 100 includes a bolt 101, a lock washer 102, a retainer in the form of a flat washer 103, a seal in the form of a curved washer 104, and a toggle assembly 105. The bolt 101 includes a threaded shaft. The head of the bolt 101 is illustrated as a Phillips drive but could include one of any number of optional drive types, such as slotted, hexagonal or square shape, as well as a specifically designed proprietary geometry. The bolt 101 may be constructed from one or more of several suitable materials, such as metal, plastic, or a composite which allows for resistance to corrosion in an outdoor environment. A length of the bolt 101 is significantly longer than the diameter of the bolt 101. Preferably, the length of the bolt 101 is greater than a wall thickness of the utility poles for which the hole plug 100 is intended for use. Such an arrangement permits the toggle assembly 105 to be deployed within the interior space of the utility pole. In some configurations, the length of the bolt 101 is sufficient to be operable with utility poles having a range of wall thicknesses. Wall thicknesses of hollow utility poles can be between about 1/16″ and about ½″, or between about ⅛″ and about 5/16″. Accordingly, the bolt 101 can have a length of between about 2″ and about 4″, or between about 3″ and about 3½″. However, other lengths of the bolt 101 can be used depending on relevant factors including, for example, the wall thickness of the utility pole for which the hole plug 100 is intended for use and the type and size of the toggle.

With reference to FIG. 1, the lock washer 102 is axially contained on the shaft of the bolt 101. The lock washer 102 may be constructed from one or more of several suitable materials, such as metal, plastic, or a composite which allows for resistance to corrosion in an outdoor environment. In some configurations, the bolt 101 and/or the lock washer 102 can be constructed from a metal material and provided with a coating, such as a black oxide coating. The lock washer 102 may be used to combat the effects of vibrations that are experienced by the electrical pole and could otherwise cause the bolt 101 to loosen and/or to maintain sufficient tension of the bolt 101 in response to material expansion and contraction resulting from temperature changes.

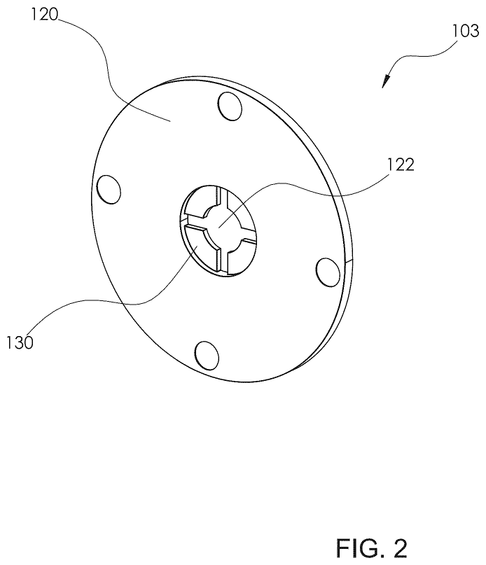

With continued reference to FIGS. 1 and 2, the flat washer 103 is supported on the shaft of the bolt 101. The flat washer 103 may be constructed from one or more of several suitable materials, such as metal, plastic, or a composite which allows for resistance to corrosion in an outdoor environment. As used herein, a washer is a thin component having a thickness dimension that is many times smaller (e.g., at least 4-10 times smaller) than a diameter or an outer dimension (e.g., one or both of a vertical/height and horizontal/width dimension). An example thickness of a washer can be between about 1/32″ and about ¼″ or between about 1 mm and about 6 or 7 mm. The flat washer 103 can be planar or flat, or can be relatively more planar or more flat than the seal washer 104. In some configurations, the flat washer 103 is a nylon material, such as nylon 6-6. In some configurations, the flat washer 103 is stiffer than the seal washer 104. The flat washer 103 can have a snug fit to the shaft of the bolt 101 to be able to resist movement along the axis of the shaft of the bolt 101 in response to a force below a threshold and to allow movement along the axis of the shaft of the bolt 101 in response to a force at or above the threshold. The threshold can be set high enough to hold the toggle assembly 105 against an inner surface of the utility pole without spinning when the bolt 101 is rotated but can be set low enough to permit a technician to manually move the flat washer 103 along the shaft of the bolt 101. Such an arrangement can allow the flat washer 103 to be used to hold the toggle assembly 105 against the inner surface of the utility pole while the technician rotates the bolt 101 to secure the hole plug 100 within the hole of the utility pole. The flat washer 103 can also provide a surface (e.g., the outer surface) for the technician to press to move the flat washer 103 and the seal washer 102 along the shaft of the bolt 101 and against the outer surface of the utility pole. The technician can optionally press on the outer surface of the flat washer 103 while tightening the bolt 101 to inhibit or prevent the flat washer 103 from rotating with the bolt 101 and/or loosening (moving away from the toggle assembly 105) while the bolt 101 is rotating.

With particular reference to FIG. 2, the illustrated flat washer 103 includes a main body portion 120 that surrounds a central opening 122. At least one tab 130 projects from the main body portion 120 towards the central opening 122. In the illustrated arrangement, the flat washer 103 includes a plurality of tabs 130. In particular, the flat washer 103 includes four tabs 130. However, other suitable number of tabs 130 could be provided, such as two, three, five, six, or more tabs 130. In the illustrated arrangement, the tabs 130 have a smaller thickness than a thickness of the main body portion 120. The central opening 122 can be smaller than a diameter of the shaft of the bolt 101 with which the flat washer 103 is intended to work. For example, the diameter of the central opening 122 can be smaller than the diameter of the shaft of the bolt 101 by between about 1% to about 10%, or more. As a result, an interference fit between the flat washer 103 and the shaft of the bolt 101 is established when the flat washer 103 is assembled onto the shaft of the bolt 101. The relatively thinner tabs 130 allows the tabs 130 to preferentially flex instead of or to a greater degree than the relatively thicker main body portion 120 to reduce or eliminate flex or distortion of the main body portion 120 and/or to ease the movement of the flat washer 103 on the shaft of the bolt 101. Any one or combination of the number, size, shape, or thickness of the tabs 130 can be selected to provide a desired level of resistance to movement of the flat washer 103 along the axis of the shaft of the bolt 101.

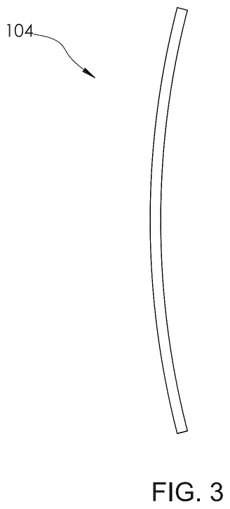

With reference to FIGS. 1 and 3, the seal washer 104 is supported on the shaft of the bolt 101. The seal washer 104 can be formed to have a curved shape, as illustrated in FIG. 3. The curved shape can be selected to be the same as or similar to the curvature of the outer surface of the portion of the utility pole surrounding the hole to be plugged or can be provided with the same or a similar curvature of common utility poles. The seal washer 104 could be provided in several different curvatures, if desired. The curvature can facilitate the seal washer 104 forming a seal with the outer surface of the utility pole to create an effective seal of the hole that is plugged by the hole plug 100. In some configurations, the curvature of the seal washer 104 can have a 6 inch, a 7 inch, a 7.5 inch, or an 8.5 inch radius, among other possible options. In some configurations, the curvature of the seal washer 104 can be between about 4 inches and about 10 inches, between about 5 inches and about 9 inches, or between about 6 inches and about 8.5 inches. In some configurations, the curvature of the seal washer 104 is in a direction parallel to the outer surface of the utility pole and/or in a direction perpendicular to a longitudinal axis of the bolt 101. In some configurations, the seal washer 104 is curved in only one dimension or only about one axis to conform to an elongated utility pole having a generally cylindrical shape. The seal washer 104 may be constructed from one or more of several suitable materials, such as metal, plastic, or a composite, which allows for flexibility to conform to the shape of the outer surface of the portion of the utility pole surrounding the hole to be plugged. The material of the seal washer 104 can be selected to provide for resistance to corrosion in an outdoor environment.

With reference to FIG. 1, the toggle assembly 105 is threaded onto the shaft of the bolt 101. In the illustrated arrangement, the toggle assembly 105 is constructed of threaded pin 106 with first wing 107 and a second wing 108 attached to the threaded pin 106 along the axis of the pin 106 and perpendicular to the axis of the shaft of the bolt 101. A wing spring 109 (shown in dashed line) is located along the axis of the threaded pin 106 and is configured to urge the first wing 107 and the second wing 108 toward an open position. The toggle assembly 105 can be collapsed, rotating the first wing 107 and the second wing 108 toward one another against the biasing force of the wing spring 109, to permit the toggle assembly 105 to be passed through a hole of a utility pole. Once passed through the hole and positioned within the interior space of the utility pole, the wing spring 109 urges the first wing 107 and the second wing 108 into the open position, as shown in FIG. 1, such that the toggle assembly 105 cannot pass back through the hole and, instead, contacts the inner surface of the utility pole that surrounds the hole. In particular, the first wing 107 and the second wing 108 contact the inner surface of the portion of the utility pole that surrounds the hole.

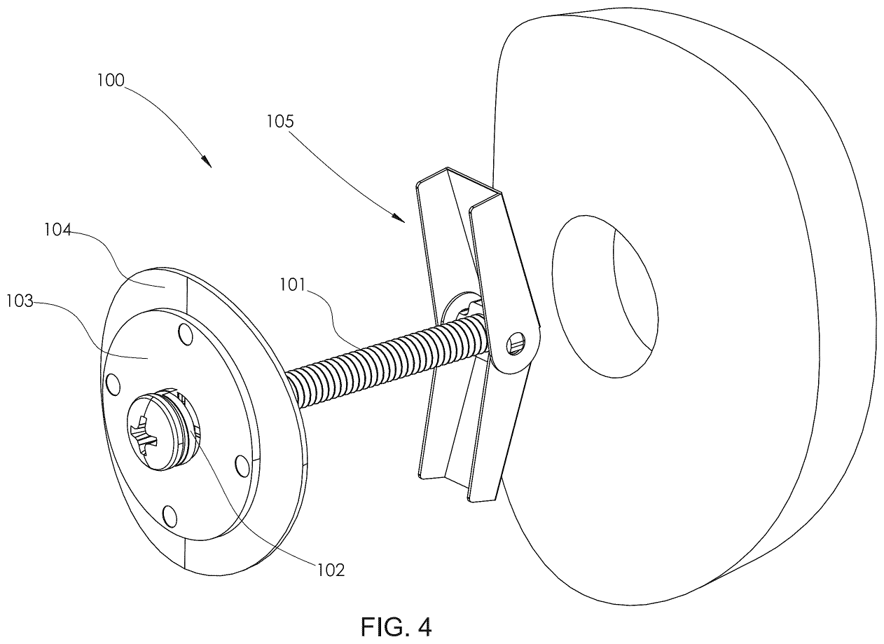

With reference to FIGS. 4-7, in operation, the toggle assembly 105 may be collapsed and inserted into a hole in a utility pole. The toggle assembly 105 can be manually collapsed by the technician or can be collapsed as a result of being forced through the hole, among other possibilities. The inner wing 107 and outer wing 108 will rotate about the axis of the threaded pin 106 and collapse around the shaft of the bolt 101 against the resistance of the wing spring 109. Once the toggle assembly 105 passes through the wall thickness of the utility pole, the inner wing 107 and outer wing 108 are moved to the opened position by biasing force of the wing spring 109.

Once the toggle assembly 105 is in the opened position, the technician may move the flat washer 103 and seal washer 104 along the shaft of the bolt 101 until the seal washer 104 is positioned against the outer surface of the utility pole. The toggle assembly 105 engages the inner surface of the utility pole and the flat washer 103 can securely hold the seal washer 104 and the toggle assembly 105 against the outer surface and the inner surface, respectively, of the utility pole. The technician may proceed to rotate the bolt 101, which may cause the toggle assembly 105 to rotate and align axially with the length of the utility pole if it is not already aligned. The bolt 101 can be continued to be tightened until the head of the bolt 101 and the lock washer 102 compresses the flat washer 103 and seal washer 104 against the outer surface of the utility pole. Advantageously, in at least some configurations, the flat washer 103 can secure the toggle assembly 105 against the inner surface of the utility pole with enough force to inhibit or prevent the toggle assembly 105 from rotating while the bolt 101 is rotated by a hand tool or, preferably, with a power driver. Such an arrangement can speed up the installation process in comparison to the use of a toggle that must be held against the inner surface of the utility pole by the technician applying a manual pulling force on the bolt 101 at the same time that the bolt 101 is being tightened.

Once the bolt 101 is tightened, the flat washer 103 may force the seal washer 104 to conform to the outer shape of the portion of the utility pole surrounding the hole, which may have one of many different profiles, from flat to curved. To help compress the seal washer 104, if necessary, the flat washer 103 can have an outer diameter that is a significant proportion of the outer diameter of the seal washer 104. In some configurations, the diameter of the flat washer 103 can be between about 60-100%, between about 75-100%, or between about 85-100% of the diameter of the seal washer 104. In some configurations, the diameter of the flat washer 103 can be at least about 60%, at least about 75%, or at least about 85% of the diameter of the seal washer 104. In some configurations, the seal washer 104 can have a diameter of at least about 1 inch, at least about 2 inches, or at least about 3 inches. In some configurations, the seal washer 104 can have a diameter of between about 1 inch and about 4 inches, between about 1 inch and about 3 inches, or between about 1 inch and about 2 inches. Although the flat washer 103 and the seal washer 104 have a circular outer shape in the illustrated arrangements, other outer shapes are also possible. Thus, references to a diameter herein can be replaced with references to an outer dimension, which can be a horizontal (lateral) and/or a vertical (longitudinal) dimension, which may be the same as or different from one another and which may be relative to an in-use orientation of the hole plug 100, or components thereof.

The lock washer 102 may deform to create a force within the bolt 101, which may inhibit or prevent the bolt 101 from loosening due to vibrations occurring within the utility pole due to wind and other external forces and/or to maintain sufficient tension of the bolt 101 in response to material expansion and contraction resulting from temperature changes. Furthermore, although the hole plug 100 is shown and configured for use with utility poles, the hole plug could be used with or modified for use with holes or other openings of other objects. Thus, the size, shape, or materials, among other features, could be modified for use in the intended application.

### Conclusion

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed:

1. A hole plug assembly for plugging a hole of a utility pole, comprising:
a bolt;
a toggle assembly engaged with the bolt;
a retainer supported by the bolt; and
a seal supported by the bolt and located between the retainer and the toggle assembly;
wherein the seal is curved in a direction perpendicular to an axis of the bolt.

2. The hole plug assembly of claim 1, wherein the seal is a seal washer.

3. The hole plug assembly of claim 1, wherein the seal washer is flexible to allow the seal washer to conform to a shape of a portion of an outer surface of the utility pole surrounding the hole plugged by the hole plug assembly.

4. The hole plug assembly of claim 1, wherein a diameter of the retainer is between about 60-100%, between about 75-100%, or between about 85-100% of the diameter of the seal.

5. The hole plug assembly of claim 1, wherein the retainer is a flat washer.

6. A hole plug assembly for plugging a hole of a utility pole, comprising:
a bolt;
a toggle assembly engaged with the bolt;
a retainer supported by the bolt; and
a seal supported by the bolt and located between the retainer and the toggle assembly;
wherein a position of the retainer along an axis of the bolt can be adjusted and thereafter the retainer resists movement along the axis in response to a force below a threshold.

7. The hole plug assembly of claim 6, wherein the retainer is a flat washer.

8. The hole plug assembly of claim 7, wherein the flat washer comprises a main body portion surrounding an opening and at least one tab extending from the main body portion towards the opening.

9. The hole plug assembly of claim 8, wherein the at least one tab has a smaller thickness than a thickness of the main body portion.

10. The hole plug assembly of claim 8, wherein the at least one tab comprises a plurality of tabs.

11. The hole plug assembly of claim 6, wherein the retainer is slidable along the axis of the bolt.

12. The hole plug assembly of claim 6, wherein the seal is a seal washer.

13. The hole plug assembly of claim 12, wherein the seal washer is curved.

14. The hole plug assembly of claim 12, wherein the seal washer is flexible to allow the seal washer to conform to a shape of a portion of an outer surface of the utility pole surrounding the hole plugged by the hole plug assembly.

15. The hole plug assembly of claim 6, wherein a diameter of the retainer is between about 60-100%, between about 75-100%, or between about 85-100% of the diameter of the seal.

16. The hole plug assembly of claim 6, wherein the diameter of the retainer is at least about 60%, at least about 75%, or at least about 85% of the diameter of the seal.

17. The hole plug assembly of claim 6, wherein the diameter of the seal is at least about 1 inch, at least about 2 inches, or at least about 3 inches.

18. The hole plug assembly of claim 6, wherein the diameter of the seal is between about 1 inch and about 4 inches, between about 1 inch and about 3 inches, or between about 1 inch and about 2 inches.
